(19) United States
(12) Patent Application Publication
(10) Pub. No.: US 2024/0407352 A1
(43) Pub. Date: Dec. 12, 2024

(54) MONITORING THE TREATMENT OF AN AGRICULTURAL FIELD

(71) Applicant: BASF AGRO TRADEMARKS GMBH, Ludwigshafen (DE)

(72) Inventors: Carvin Guenther SCHEEL, Keoln (DE); Clemens Christian DELATREE, Muenster (DE); Volker NIGGE, Muenster (DE); Hubert SCHMEER, Odenthal (DE); Andreas GERLACH, Koeln (DE)

(21) Appl. No.: 18/703,091

(22) PCT Filed: Oct. 26, 2022
(86) PCT No.: PCT/EP2022/079856

§ 371 Date: Apr. 19, 2024

(30) Foreign Application Priority Data
Oct. 26, 2021 (EP) 21204882.1

(51) Int. Cl. A01M 7/00; A01B 79/00

(52) U.S. Cl. CPC A01M 7/0089; A01B 79/005

(57) ABSTRACT

A computer-implemented method for monitoring the treatment of an agricultural field (11) with a pesticide product by an agricultural machine (10), wherein the agricultural machine (10) comprises at least one sensor device (31) and at least one treatment component comprising at least one nozzle (21), the method comprising the steps: providing (40) location-specific sensor data of the agricultural field (10) from the at least one sensor device (31); analyzing (42) the location-specific sensor data with respect to at least one harmful organism as one treatment indicator; generating location-specific control data for the at least one treatment component based on the analyzed location¬ specific sensor data; providing (44) a pesticide savings parameter in real-time, wherein the pesticide savings parameter relates to an amount of pesticide product based on the location-specific sensor data in relation to an amount of pesticide product based on a reference treatment with a pesticide product.

The present disclosure relates to a computer-implemented method for monitoring the treatment of an agricultural field by an agricultural machine in real-time, a computing apparatus, a control unit, a treatment device an agricultural machine and a computer program or computer readable non-volatile storage medium for performing the method.

### BACKGROUND

The general background of this disclosure is the treatment of plants in an agricultural area, which may be an agricultural field, a greenhouse, or the like. The treatment of plants, such as the actual crops or the like, may also comprise the treatment of weed present in the agricultural area, the treatment of the insects present in the agricultural area, the treatment of the soil of the agricultural area as well as the treatment of pathogens present in the agricultural area.

In existing systems, cases may occur where reduced data handling and computing capabilities are present.

### SUMMARY OF THE INVENTION

Therefore, there is a need to provide means for improving treatment monitoring and data aggregation, particularly in terms of comparability. It is accordingly an object of the present invention to provide more efficient and/or effective means for monitoring and treating an agricultural field. This object is solved by the subject-matter of the independent claims.

According to a first aspect of the present disclosure, a computer-implemented method for monitoring the treatment of an agricultural field by an agricultural machine in real-time is provided, wherein the agricultural machine comprises at least one sensor device and at least one treatment component, comprises the steps of providing location-specific sensor data of the agricultural field from the at least one sensor device, analyze the location-specific sensor data with respect to at least one treatment indicator and provide a treatment savings parameter, wherein the treatment savings parameter relates to an amount of treatment based on the location-specific sensor data in relation to an amount of treatment based on a reference treatment. In this way, the real-time data is aggregated with data from a reference treatment and comparison and data processing is facilitated. Further use by the one or other agricultural machines is enhanced.

A further aspect of the present disclosure relates to a computer-implemented method for monitoring the treatment of an agricultural field with a pesticide product by an agricultural machine, wherein the agricultural machine comprises at least one sensor device and at least one treatment component comprising at least one nozzle, the method comprising the steps: providing location-specific sensor data of the agricultural field from the at least one sensor device; analyzing the location-specific sensor data with respect to at least one harmful organism as one treatment indicator; generating location-specific control data for the at least one treatment component based on the analyzed location-specific sensor data; providing a pesticide savings parameter in real-time, wherein the pesticide savings parameter relates to an amount of pesticide product based on the location-specific sensor data in relation to an amount of pesticide product based on a reference treatment with a pesticide product.

In a further aspect of the present disclosure, the pesticide product is a herbicide product, the sensor device comprises at least one optical sensor and a number of weed plants and/or a density of weed is the at least one treatment indicator.

In a further aspect of the present disclosure, the method comprises additionally the step: adopting the control data for the at least one treatment component such that the pesticide savings parameter is set to 0; or such that an application is made with a predetermined application rate, i.e. a flat-application rate; or such that the threshold value for the application of the pesticide product is decreased or increased. A threshold value is understood to mean the value of the treatment indicator from which a treatment with a pesticide product takes place. If, for example, the treatment indicator is a weed density, then the threshold value can be used to specify at which weed density value an application with a herbicide takes place.

Reference treatment comprises data from a different treatment, for example, data from a flat, i.e. uniform, treatment, historic data from the same agricultural field, data from a nearby agricultural field or from another agricultural field sharing relevant traits.

The method may comprise additionally the step of generating location-specific control data based on the location-specific sensor data for at least one treatment component. In this way, the aggregated data can be directly used to facilitate the control data generation.

In a further aspect of the present disclosure, the location-specific control data relates to a location-specific on/off-operation of at least one treatment component. In this way, having a binary option only, data processing and transmission requirements are reduced.

In another aspect of the present disclosure, the method comprises additionally the step of controlling the at least one treatment component based on the location-specific control data. In this way, the aggregated data can be directly used to facilitate the control of the treatment component.

In another aspect of the present disclosure, the amount of treatment based on a reference treatment is not location-specific. In this way, the requirements for the needed data storage and processing means are reduced.

In another aspect of the present disclosure, the method comprises additionally the step of displaying the treatment savings parameter on a display unit. In this way, monitoring the treatment is facilitated.

In an even further aspect of the present disclosure, the method comprises additionally the step of updating the treatment savings parameter in real time. In this way, monitoring the treatment is facilitated, allowing for real-time adjustments and reactions.

In another aspect of the present disclosure, the treatment savings parameter is stored in a map of the agricultural field, in particular in a location-specific map of the agricultural field. In this way, further use for other agricultural machines or later treatments is facilitated.

In another aspect of the present disclosure, a computing apparatus is disclosed, especially a distributed computing system, comprising a communication interface for receiving and sending data, the computing apparatus being configured to receive location-specific sensor data via the communication interface, to analyze the location-specific sensor data with respect to at least one treatment indicator and to generate control data and send out the control data via the communication interface.

A treatment indicator can comprise at least one characteristic of the soil, the plant cover, the weather, life forms, cultivation phase, time, the treatment, in particular the type of treatment or the treatment product, and any other agricultural relevant parameter. It is used to determine the type and amount of treatment, which should be executed.

In another aspect of the present disclosure, a control unit for operating a treatment device for applying a treatment product to an agricultural field is disclosed. The control unit comprises a communication interface for sending and receiving data and the treatment device comprises at least one treatment component, wherein the control unit is configured receive control data and to provide control data to control the at least one treatment component.

In another aspect of the present disclosure, a treatment device for applying a treatment product to an agricultural field is disclosed. The treatment device comprises at least one treatment component and at least one sensor device. The treatment device is adapted to perform any of the above methods.

In another aspect of the present disclosure, an agricultural machine is disclosed. The agricultural machine comprises a computing apparatus, a control unit and a treatment device and is adapted to perform any of the above methods.

In another aspect of the present disclosure, a computer program or computer readable non-volatile storage medium is disclosed, comprising computer readable instructions, which when loaded and executed by a computing apparatus perform the methods of any of the above methods and/or control the treatment device and/or the agricultural machine.

The term “agricultural machine” is to be understood broadly in the present case and comprises any machine configured to treat an agricultural field. The agricultural machine may be configured to traverse the agricultural field. The agricultural machine may be a ground or an air vehicle, e.g. a tractor, a rail vehicle, a robot, an aircraft, an unmanned aerial vehicle (UAV), a drone, or the like. The agricultural machine may by equipped with one or more treatment devices. The treatment device may be configured to collect field data via treatment components and/or sensor devices. The treatment device may be configured to sense field data of the agricultural field via the sensor device. The treatment device may be configured to treat the agricultural field via the treatment component. The agricultural machine may be equipped with or operatively coupled with different apparatuses, for example a geolocation device, a communication interface, a sensor device, a control unit, a communication device, computing means and the like. Additionally, the agricultural machine may comprise a sensor device for acquiring a measure of the amount of treatment and/or treatment product applied to the agricultural field.

Treatment component(s) may be operated based on sensor signals provided by the sensor device(s) of the treatment device. The treatment device may comprise a communication interface and/or unit for connectivity. Via the communication unit the treatment device may be configured to provide, receive or send field data, to provide, send or receive operation data and/or to provide, send or receive control data.

The term “real-time” is to be understood broadly in the present case and is preferably understood as not more than 15 minutes, more preferably not more than 10 minutes, most preferably not more than 5 minutes, particularly preferably not more than 2 minutes, particularly more preferably not more than 60 seconds, particularly most preferably not more than 30 seconds, particularly not more than 15 seconds, particularly for example not more than 5 seconds, for example not more than 2 seconds. In other words, the pesticide savings parameter should be updated and displayed in said real time.

Such a real-time update makes it possible to intervene relatively quickly in the application of the pesticide or any other product. For example, it is possible to switch to a so-called flat application, so that no more pesticide savings are achieved, but a high efficacy can be assumed. Alternatively, it is possible to adapt the threshold values in order to influence the application of the product.

The term “pesticide” and/or “pesticide product” as used herein is to be understood broadly and encompasses any herbicide, fungicide, insecticide, acaricide, molluscicide, nematicide, avicide, piscicide, rodenticide, repellant, bactericide, biocide, safener, plant growth regulator, urease inhibitor, nitrification inhibitor, denitrification inhibitor, or mixtures thereof, i.e. the present disclosure is not limited to a specific kind of pesticide product. The term “herbicide product” as used herein is to be understood broadly in the present case and presents any herbicide material to be applied onto an agricultural field. Herbicides can specifically be referred to as selective or non-selective herbicides. A selective herbicide controls specific weed species, while leaving the desired crop relatively unharmed. In contrast, a non-selective herbicides, e.g. called total weed killers, kill all plant material with which they come into contact. A herbicide may be at least one one of the following, but is not limited thereto: acetamides, amides, aryloxyphenoxypropionates, benzamides, benzofuran, benzoic acids, benzothiadiazinones, bipyridylium, carbamates, chloroacetamides, chlorocarboxylic acids, cyclohexanediones, dinitroanilines, dinitrophenol, diphenyl ether, glycines, imidazolinones, isoxazoles, isoxazolidinones, nitriles, N-phenylphthalimides, oxadiazoles, oxazolidinediones, oxyacetamides, phenoxycarboxylic acids, phenylcarbamates, phenylpyrazoles, phenylpyrazolines, phenylpyridazines, phosphinic acids, phosphoroamidates, phosphorodithioates, phthalamates, pyrazoles, pyridazinones, pyridines, pyridinecarboxylic acids, pyridinecarboxamides, pyrimidinediones, pyrimidinyl(thio)benzoates, quinolinecarboxylic acids, semicarbazones, sulfonylaminocarbonyltriazolinones, sulfonylureas, tetrazolinones, thiadiazoles, thiocarbamates, triazines, triazinones, triazoles, triazolinones, triazolocarboxamides, triazolopyrimidines, triketones, uracils, ureas. Further, a herbicide may be, but are not limited thereto, lipid biosynthesis inhibitors, acetolactate synthase inhibitors (ALS inhibitors), photosynthesis inhibitors, protoporphyrinogen-IX oxidase inhibitors, bleacher herbicides, enolpyruvyl shikimate 3-phosphate synthase inhibitors (EPSP inhibitors), glutamine synthetase inhibitors, 7,8-dihydropteroate synthase inhibitors (DHP inhibitors), mitosis inhibitors, inhibitors of the synthesis of very long chain fatty acids (VLCFA inhibitors), cellulose biosynthesis inhibitors, decoupler herbicides, auxinic herbicides, auxin transport inhibitors, and/or other herbicides selected from the group consisting of bromobutide, chlorflurenol, chlorflurenol-methyl, cinmethylin, cumyluron, dalapon, dazomet, difenzoquat, difenzoquat-metilsulfate, dimethipin, DSMA, dymron, endothal and its salts, etobenzanid, flamprop, flamprop-isopropyl, flamprop-methyl, flamprop-M-isopropyl, flamprop-M-methyl, flurenol, flurenol-butyl, flurprimidol, fosamine, fosamine-ammonium, indanofan, indaziflam, maleic hydrazide, mefluidide, metam, methiozolin, methyl azide, methyl bromide, methyl-dymron, methyl iodide, MSMA, oleic acid, oxaziclomefone, pelargonic acid, pyributicarb, quinoclamine, tetflupyrolimet, triaziflam, tridiphane, and their agriculturally acceptable salts, amides, Isoxaflutole, Flufenacet, S-Metolachlor, Pendimethalin, Acetochlor, Pyroxasulfone, Cloransulam-methyl, Imazamethayr, Dimethenamid-P, Metamitrion, Ethofumesate, Quimerac, Prosulfocarb, Chlortoluron, Cinmethylin, Pendimethalin, esters or thioesters.

The term “weed distribution” as used herein is to be understood broadly in the present case and presents any data/information defining or indicating the existence, distribution and/or appearance of weed plants on the agricultural field. Weed plants are unwanted plants which should be controlled by using herbicides. The weed distribution data may be depicted as 2-dimensonal for one season or a plurality of seasons. The weed distributing data may be historical data indicating/depicting areas of high appearance/high density, i.e. hot-spots, of weeds. The weed distribution data may be provided by scouting, camera or sensor based mapping analysis methods.

The term “historical treatment” and/or “historic treatment” as used herein is to be understood broadly in the present case and presents any data/information providing, defining, describing or indicating historical treatments of the agricultural field. Specifically, the historical treatment data may comprise information about treatments performed in previous seasons on the agricultural field. The historical treatment data may be provided as 2-dimensional maps of the agricultural field depicting either treatment information for one specific previous season/sum of a plurality of specific previous seasons, e.g. depending on weather influences, or a sum for all previous seasons. The historical treatment data are provided by a database and/or a data system.

The term “agricultural field” as used herein is to be understood broadly in the present case and presents any area, i.e. surface and subsurface, of a soil to be treated by e.g. seeding, planting and/or fertilizing. The agricultural field may be any plant or crop cultivation area, such as a farming field, a greenhouse, or the like. A plant may be a crop, a weed, a volunteer plant, a crop from a previous growing season, a beneficial plant or any other plant present on the agricultural field. The agricultural field may be identified through its geographical location or geo-referenced location data. A reference coordinate, a size and/or a shape may be used to further specify the agricultural field.

The term “providing” as used herein is to be understood broadly in the present case and represents any providing, receiving, querying, measuring, calculating, determining, transmitting of data, but is not limited thereto. Data may be provided by a user via a user interface, depicted/shown to a user by a display, and/or received from other devices, queried from other devices, measured other devices, calculated by other device, determined by other devices and/or transmitted by other devices.

The term “data” as used herein is to be understood broadly in the present case and represents any kind of data. Data may be single numbers/numerical values, a plurality of a numbers/numerical values, a plurality of a numbers/numerical values being arranged within a list, 2 dimensional maps or 3 dimensional maps, but are not limited thereto.

The term “control data” as used herein is to be understood broadly in the present case and presents any data being configured to operate and control the agricultural machine and/or the treatment component. The control data may be provided by a control unit and may be configured to control one or more technical means of the agricultural machine and/or treatment component.

The term “harmful organism” is understood to be any organism which has a negative impact to the growth or to the health of the agricultural crop plant. Preferably, the harmful organism is selected from the group consisting of weeds, fungi, viruses, bacteria, insects, arachnids, nematodes, mollusks, birds, and rodents, more preferably, the harmful organism selected from the group consisting of weeds, fungi, and insects, most preferably, the harmful organism is weed.

### BRIEF DESCRIPTION OF THE DRAWINGS

Any disclosure and embodiments described herein relate to the methods, the apparatuses, the devices, the machines and the computer program lined out above and vice versa. Advantageously, the benefits provided by any of the embodiments and examples equally apply to all other embodiments and examples and vice versa.

As used herein “determining” also includes “initiating or causing to determine”, “generating” also includes “initiating or causing to generate” and “providing” also includes “initiating or causing to determine, generate, select, send or receive”. “Initiating or causing to perform an action” includes any processing signal that triggers a computing means to perform the respective action.

The methods, systems and computer means disclosed herein provide an efficient, sustainable and robust way for treating an agricultural field. By considering the monitoring and treatment status from the first agricultural machine, a second agricultural machine can be operated to treat a specific section of the agricultural field based on the monitoring and treatment status obtained by the first agricultural machine that specific section. Overall, this provides more tailored and more sustainable operation, since the second agricultural machine can treat based on the field data already acquired by the first agricultural machine. Multiple agricultural machines can hence be operated in an efficient, quasi on-demand manner.

The present disclosure can provide an efficient, sustainable and robust way of treating an agricultural field. These and other objects, which become apparent upon the following description, are solved by the subject matter of the independent claims. The dependent claims refer to preferred embodiments of the invention.

Exemplary embodiments will be described in the following with reference to the following drawings:

FIG. 1 shows an agricultural machine and an agricultural field, according to an embodiment.

FIG. 2 shows a distributed computing system including an agricultural machine, according to an embodiment.

FIG. 3 shows an example of a treatment device, according to an embodiment.

FIG. 4 shows a flow chart of the method for monitoring the treatment of an agricultural field by an agricultural machine, according to an embodiment.

FIG. 5 shows an embodiment of determining a treatment savings parameter

FIG. 6 shows another embodiment of determining a treatment savings parameter;

FIG. 7 shows an even further embodiment of determining a treatment savings parameter;

FIG. 8 shows an embodiment of a display output of a display, operatively coupled with an agricultural machine;

FIG. 9 illustrate example embodiments of a centralized and a decentralized computing environment with computing nodes;

FIG. 10 illustrate example embodiments of a centralized and a decentralized computing environment with computing nodes; and

FIG. 11 illustrate an example embodiment of a distributed computing environment.

### DETAILED DESCRIPTION OF EMBODIMENTS

The disclosure is based on the finding that agricultural fields comprise heterogeneous characteristics (e.g. plant, weed, soil, etc.) distributed over the entire agricultural field. These characteristics are not permanent and therefore not completely known before the agricultural machines treat the agricultural field. By monitoring with sensor devices of an agricultural machine during a treatment process of an agricultural field, these specific characteristics of the agricultural field are at least partly revealed. The collected information about these specific characteristics serves to beneficially improve the treatment strategy of the one or more further agricultural machines. By doing so, it is possible to (re-)act on changing conditions in the agricultural field on demand. In other words, the method collects field data via means of the first and/or further agricultural machines passing through the agricultural field and provides data based on the field data, also for the second and/or further agricultural machines. This enables a demand driven treatment of the agricultural field with a plurality of agricultural machines and advantageously increases the treatment efficiency.

The following embodiments are mere examples for implementing the methods, the systems or the computer elements disclosed herein and shall not be considered limiting

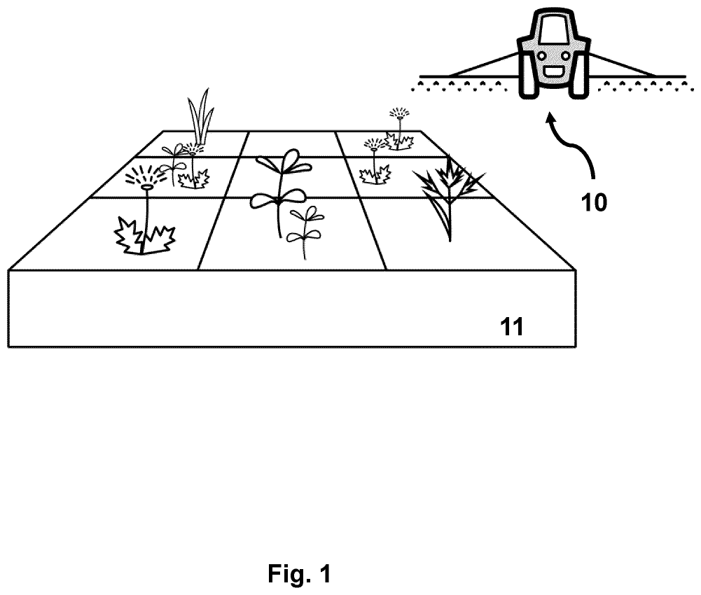

FIG. 1 shows a general overview of an agricultural machine 10 and an agricultural field 11. The agricultural machine 10 is configured for treatment of the agricultural field 11 with crops cultivated and may comprise at least one sensor device (not shown) and at least one treatment component (not shown). Further, the agricultural field 11, may be any plant or crop cultivation area, such as a field, a greenhouse, or the like, at a geo-referenced location. As indicated in FIG. 1 by interlines, the agricultural field 11 may optionally be divided into two or more subareas illustrating zone-specific or location-specific specificity. The division of the agricultural field 11 in subareas may depend on the number and distribution of treatment components and/or sensor devices.

Additionally or alternatively, the division of the agricultural field 11 may depend on the crops cultivated and/or at least one characteristic of an agricultural machine, for example a track width, a velocity or a working width. The agricultural field 11 may be treated by use of at least one of a treatment product, e.g. an herbicide, pesticide, insecticide, fungicide, nutrient.

The agricultural machine 10 crosses the agricultural field 11 at a velocity v. The agricultural machine 10 may cross the agricultural field 11 using a drive lane, in particular, the agricultural machine 10 may cross the agricultural field 11 at a substantially constant velocity and drive lanes may be arranged at a substantially equal spacing across the agricultural field 11. During the crossing of the agricultural field 11 the at least one sensor device may acquire location-specific sensor data in real-time from a specific location at or nearby the current location of the agricultural machine 10 in real-time. Preferably, the location-specific sensor data may be acquired repeatedly at a substantially constant frequency and/or at substantially uniform distances across the agricultural field.

The location-specific sensor data may be further processed by a computing means to derive control data, for example in form of a control file, to control the agricultural machine 10, a treatment device, the treatment component(s) and/or other components of the agricultural machine.

Based on the location-specific sensor data, the treatment component can be activated, blocked and/or adjusted to treat the agricultural field 11.

In particular, the treatment can be performed in substantially uniform subareas, which can be for example defined by the treatment area covered by a treatment component during a substantially fixed amount of time, for example by a single or a multiple of the location-specific sensor data acquisition time and/or dependent on the velocity of the agricultural machine 10.

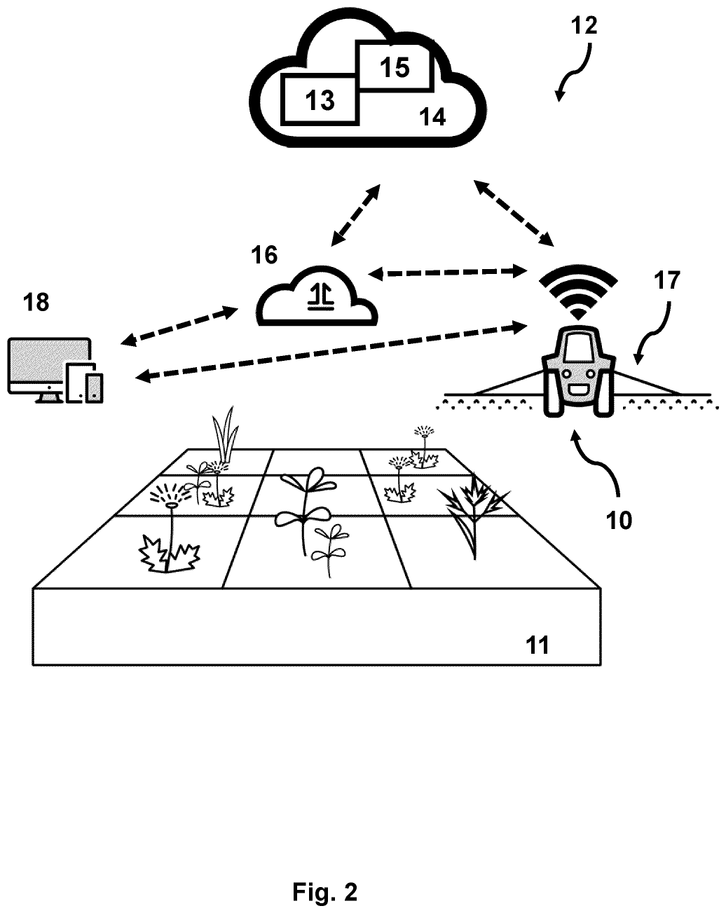

FIG. 2 shows a general overview of a system 12 that is configured for treatment on or at an agricultural field 11, at or on which e.g. crops are to be cultivated. The agricultural field 11 may to be treated by use of a treatment product, which may also be referred to as an agrochemical, e.g. an herbicide, pesticide, insecticide, fungicide, or the like.

Further, the agricultural field 11, may be any plant or crop cultivation field, such as a field, a greenhouse, or the like, at a geo-referenced location. As indicated in FIG. 2 by interlines, the agricultural field 11 may optionally be divided into two or more subareas.

The system 12 may comprise or form a distributed computing environment. It may comprise one or more of an agricultural machine 10, a first computing resource or means 14, a second computing resource or means 16, and a third computing resource or means 18. The agricultural machine 10 and/or the first, second and third computing means 14, 16, 18, may at least partly be remote to each other. At least some of the agricultural machine 10 and the first, the second and the third computing means 14, 16, 18 may comprise one or more of a data processing unit, a memory, a data interface, a communication interface, etc. Within the system 12, the agricultural machine 10 and the first, the second and the third computing means 14, 16, 18 may be configured to communicate with each other via communication means, such as a communications network, as indicated in FIG. 2 by dashed lines between the entities 10, 14, 16, 18. The agricultural machine 10 may also be referred to as a smart farming machinery. The agricultural machine 10 may be e.g. a vehicle, such as a tractor or the like, an aircraft, a robot, a smart sprayer, or the like, and may be configured to be operated, for example, computer-aided, by a remote control and/or at least semi-autonomous. The agricultural machine 10 may, for example, comprise and/or carry a treatment device 17, which may be e.g. a spraying device for application of a treatment product as described above.

The first computing means 14 may be a data management system configured to send data to the agricultural machine 10 and/or to receive data from agricultural machine 10. For example, the data received from the agricultural machine 10 may comprise one or maps, such as a growth distribution map, a weed distribution map, or the like, which may be generated and/or provided based on data recorded during operation of the agricultural machine 10 and/or application of the treatment product at or on the agricultural field 11.

The second computing means 16 may be a field management system configured to generate and/or provide a control parameter set, which may comprise one or more of control data for operating the agricultural machine 10, a control protocol, an activation code, a set of threshold adjustments or a basic threshold, a decision logic to the agricultural machine 10, and/or to receive data from the agricultural machine 10. Such data may also be provided and/or received through the first computing means 14. The third computing means 18 may be a client computer configured to receive client data from and/or to provide data to at least the second computing means 16 and/or the agricultural machine 10. Such client data may, for example, comprise an application schedule for the treatment product to be applied on a specific agricultural area by operating the agricultural machine 10.

Additionally or alternatively, the client data may comprise field analysis data to provide insights into the health state, weed information, plant or crop information, geo-location data, or the like, of a specific agricultural area.

Further, when data is monitored, collected and/or recorded by the agricultural machine 10, such data may be distributed to one or more of, or even to every, computing means 14, 16, 18 of the distributed computing environments.

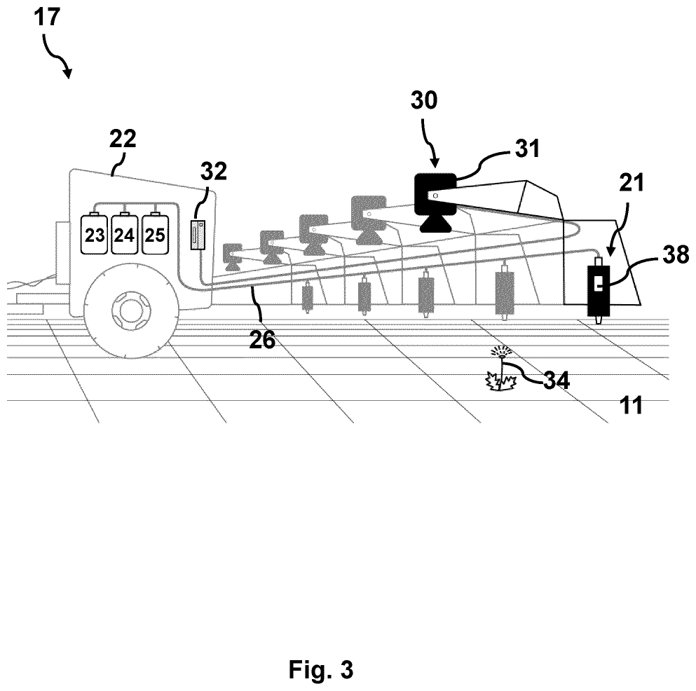

FIG. 3 shows an example of the treatment device 17. It is noted that FIG. 3 is merely a schematic, illustrating main components, wherein the treatment device 17 may comprise more or less components than actually shown. In particular, the treatment device 17, e.g. its fluidic set up as shown, may comprise more components, such as dosing or feed pumps, mixing units, buffer tanks or volumes, distributed line feeds from multiple tanks, back flow, cyclic recovery or cleaning arrangements, different types of valves like check valves, ½ or ⅔ way valves and so on. Also different fluidic set ups and mixing arrangements may be chosen. The present disclosure is, however, applicable to all fluidic setups.

The treatment device 17 shown in FIG. 3 is part of the agricultural machine 10 (as shown in FIGS. 1 and 2) for applying the treatment product on the agricultural field 11 or on one or more subareas thereof. The treatment device 17 may be releasably attached or directly mounted to the agricultural machine 10. In at least some embodiments, the treatment device 17 comprises a boom with multiple treatment components 21, here spray nozzles 21 arranged along the boom of the treatment device 17.

The spray nozzles 21 may be fixed or may be attached movable along the boom in regular or irregular intervals. Each spray nozzle 21 may arranged together with one or more, preferably separately, controllable valves 38 regulate fluid release from the spray nozzles 21 to the agricultural field 11.

One or more tank(s) 23, 24, 25 are in fluid communication with the nozzles 21 through one or more fluidic lines 26, which distribute the one or more treatment products as released from the tanks 23, 24, 25 to the spray nozzles 21. This may include chemically active or inactive ingredients like a treatment product or mixture, individual ingredients of a treatment product or mixture, a selective treatment product for specific weeds, a fungicide, a fungicide or mixture, ingredients of a fungicide mixture, ingredients of a plant growth regulator or mixture, a plant growth regulator, water, oil, or any other treatment product. Each tank 23, 24, 25 may further comprise a controllable valve (not shown) to regulate fluid release from the tank 23, 24, 25 to fluid lines 26. Such arrangement allows to control the treatment product or mixture released to the agricultural field 11 in a targeted manner depending on the conditions determined for the agricultural field 11.

For monitoring and/or detecting, the agricultural machine 10 (as shown in FIG. 1) and/or the treatment device 17 may comprise a sensor system 30 with sensor devices 31 arranged along e.g. the boom. The sensor devices 31 may be arranged fixed or movable along the boom in regular or irregular intervals. The sensor devices 31 are configured to sense one or more conditions of the agricultural field, for example plants 34 or insects. The sensor devices 31 may be an optical sensor device 31 providing an image of the field. Suitable optical sensor devices 31 are multispectral cameras, stereo cameras, IR cameras, CCD cameras, hyperspectral cameras, ultrasonic or LIDAR (light detection and ranging system) cameras. Alternatively or additionally, the sensor devices 31 comprise further sensors to measure humidity, light, temperature, wind or any other suitable condition on the agricultural field 11.

In at least some embodiments, the sensor devices 31 may be arranged perpendicular to the movement direction of the treatment device 17 and in front of the nozzles 21 (seen from drive direction). In the embodiment shown in FIG. 3, the sensor devices 31 are optical sensor devices and each sensor device 31 is associated with a single nozzle 21 such that the field of view comprises or at least overlaps with the spray profile of the respective nozzle 21 on the field once the nozzle reach the respective position. In other arrangements, each sensor device 31 may be associated with more than one nozzle 21 or more than one sensor device 31 may be associated with each nozzle 21.

The sensor devices 31, the tank valves and/or the nozzle valves 38 are communicatively coupled to a control unit 32. In the embodiment shown in FIG. 3, the control unit 32 is located in a main treatment device housing 22 and wired to the respective components. In another embodiment sensor devices 31, the tank valves or the nozzle valves 38 may be wirelessly connected to the control unit 32. In yet another embodiment more than one control unit 32 may be distributed in the treatment device housing 22 or the agricultural machine 10 and communicatively coupled to sensor devices 31, the tank valves or the nozzle valves 38. The control unit 32 may be configured to control and/or monitor the sensor devices 31, the tank valves or the nozzle valves 38 based on control data a control file, a parameter set and/or following a control protocol. In this respect, the control unit 32 may comprise multiple electronic modules. One module for instance may control the sensor devices 31 to collect data such as an image of the agricultural field 11. A further module may analyze the collected data such as the image to derive parameters for the tank or nozzle valve control. Yet further module(s) may control the tank valves and/or nozzle valves 38 based on such derived parameters.

In an exemplary embodiment, the sensor device may comprise a fluid sensor operatively coupled with the fluidic lines 26. Additionally or alternatively, the sensor device may alternatively or additionally comprise a tank sensor for a tank of the agricultural machine.

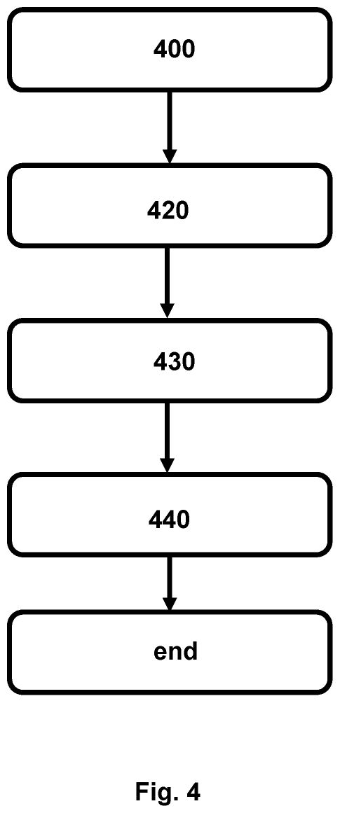

FIG. 4 shows a flow chart of a method for monitoring the treatment of an agricultural field by an agricultural machine, according to an embodiment. In a first step 400, location-specific sensor data from a sensor device acquired in real-time may be provided to a computing means.

The computing means may be completely or partly a part of the agricultural machine 10, or a distributed computing system and may comprise mobile devices communicatively coupled to the computing means.

In a second step 420, the location-specific sensor data may be analyzed with respect to at least one treatment indicator by the computing means.

In a third step 430, location-specific control data for the at least one treatment component are generated based on the analyzed location-specific sensor data.

In a fourth step 440, a treatment savings parameter for the treatment is provided. The treatment savings parameter characterizes the amount of treatment based on the location-specific sensor data in relation to an amount of treatment based on a reference treatment.

In one example, the treatment savings parameter is a comparison between a determined amount of treatment and a flat rate treatment, wherein the same amount of treatment is applied on the agricultural field. Additionally or alternatively, the reference treatment can also comprise historic data, in particular data from historic treatments.

In one exemplary embodiment, a comparison between the location-specific sensor data and a threshold is used to determine if the treatment component should be activated, for example switched between an on- and off-state. Alternatively or additionally, the strength of the activation and therefore the locally applied dosage can be controlled.

As an example, the number or density of weed present in the specific location of the agricultural field can be used. Alternatively or additionally, the number or density of cultivated crops present in the specific location of the agricultural field can be used. The threshold may be determined before the treatment based on previous available data and it may be adapted during the treatment.

The treatment savings parameter for a treatment can be defined in several ways, depending on the available data. The treatment savings parameter is a relation between data derived from in real-time acquired location-specific sensor data and reference treatment data.

In one exemplary embodiment, the treatment savings parameter can relate to a derived amount of treatment, which is not to be applied, and the reference data can relate to the amount of treatment used during a flat rate treatment.

In another exemplary embodiment, the treatment savings parameter can relate to the not applied amount of treatment and the reference data can relate to the amount of treatment used during a flat rate treatment.

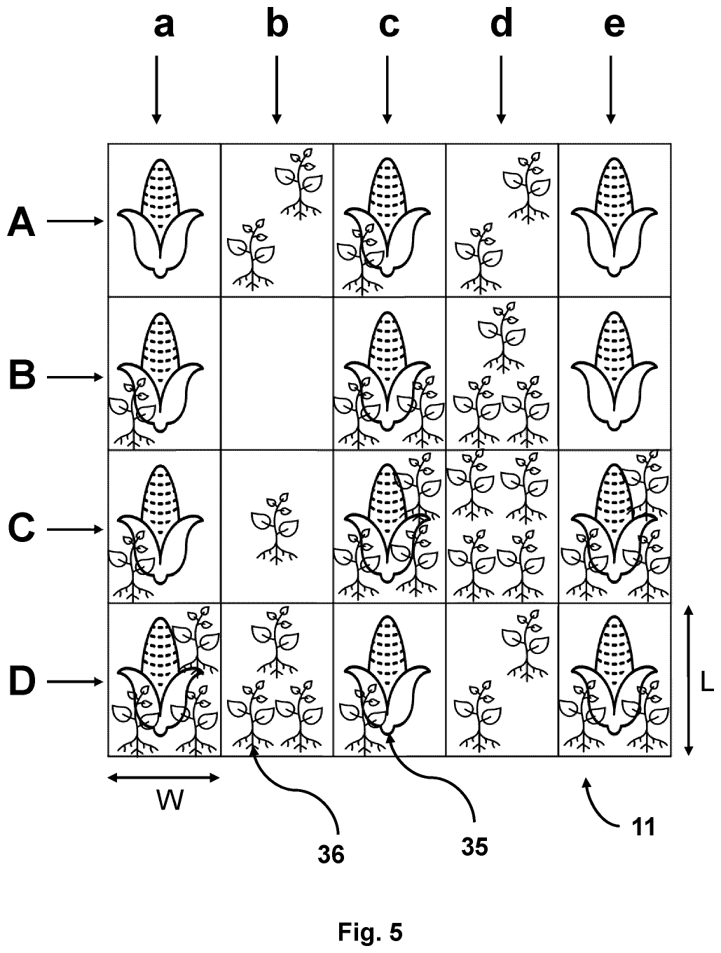

In FIGS. 5 to 7 a part of an agricultural field 11 is depicted, which is divided into subareas. The rows of the subareas are here labeled by capital letters A-D. A′-D′ and A″-D″, and the columns by small letters a-e, a′-e′ and a″-e″, such that a specific subarea can then be addressed by its row and column letter. The agricultural field 11 comprises exemplarily crop plants 35 and weed plants 36. The number of weed plants exemplarily depicts an amount of weed present in the subarea, such that a subarea with two weed plants 35 has a higher amount of weed than a subarea with just one weed plant 36. The depicted crop plants 35 exemplarily depicts the presence of crops. The subareas of the agricultural field 11 are divided based on the working parameters of an agricultural machine 10. The agricultural machine 10 has a number of treatment components with a working width W and a working length L. The sensor device of each treatment component acquires location-specific data for each subarea in real-time and the treatment is performed based on it.

In the embodiment depicted in FIG. 5, the treatment performed is spraying a herbicide to counter weed plants 36. The agricultural machine for spraying is an agricultural sprayer comprising a treatment component in form of a nozzle and a camera device as sensor device. Historic treatment data about spraying a herbicide to counter the weed plants 36 is present, for example in a remote database or a local storage device. In this example the treatment indicator is the presence of weed 36. The spraying is performed if the amount of weed 36 detected on the subareas is above a certain threshold. For example, the treatment component can be activated if the number of weed plants 36 present in a subarea is above two.

Therefore, treatment is performed in this example on the subareas Da, Db, Cc, Bd, Cd and Ce. No treatment is performed on the subareas Aa-Ca, Ab-Cb, Ac, Bc, Dc, Ad, Dd, Ae, Be and De. From the historic treatment data it is derived that treatment was done on all subareas, a flat treatment.

The treatment savings parameter can then be determined based on the number of non-treated subareas divided by the number of treated subareas derived from the historic treatment data in real-time. To illustrate the method, treatment is performed from rows D to A and over all columns a to e at the same time. So the treatment savings parameter could start to amount from 3/5=60% after treating row D, to 5/10=50% after treating rows D and C, to 9/15=60% after treating rows D to B and to 14/20=70% after treating rows D to A. Alternatively or additionally to an accumulated treatment savings parameter, a treatment savings parameter for each row can be determined in real-time. The treatment savings parameter for row D would be 3/5=60%, for row C 2/5=40%, for row B 4/5=80% and for row A 5/5=100%.

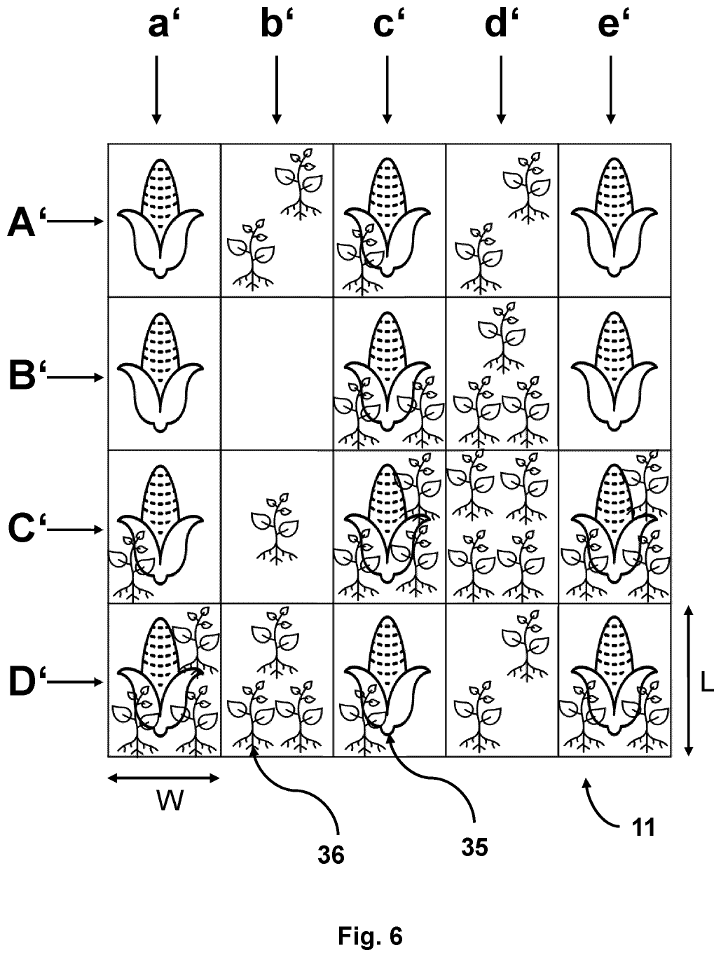

In the embodiment depicted in FIG. 6, the treatment performed is also spraying a herbicide to counter the weed plants 36. In this example a first treatment indicator is the presence of crop 35 and a second treatment indicator is the presence of weed 36. The spraying is performed if the amount of weed 36 detected on the subareas without crop 35 is above a first threshold and if the amount of weed 36 detected on the subareas with crop 35 is above a second threshold. For example, the treatment component can be activated if the number of weed plants 36 is above two and the no crop 35 is present and if the number of weed plants 36 is above one when crop 35 is present.

The treatment savings parameter can then be determined for example based on the number of treatment component activations and the number of possible operations or the number of subareas, in particular from a log file generated by the agricultural machine and updated when activating, not activating and/or blocking the one or more treatment components of the agricultural machine. In this example the treatment savings parameter for row D′ could be derived in real time to 1-3/5=40%, for row C′ 1-3/5=40%, for row B′ 1-2/5=60% and for row A′ 1-5/5=100%. An accumulated treatment savings parameter for a treatment starting from row D′ to row A′ could the be derived to be 1-3/5=40% after treating row D′, 1-6/10=40% after treating rows D′ and C′, 1-8/15=46.67% after treating rows D′ to B′ and 1-13/20=70% after treating rows D′ to A′.

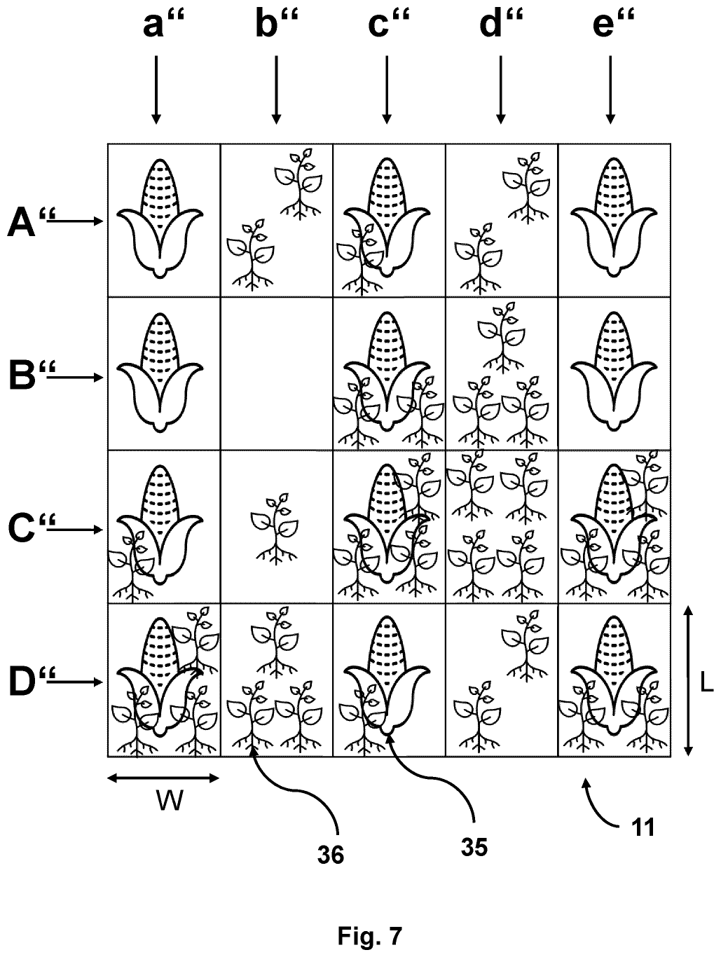

In the embodiment depicted in FIG. 7, the treatment performed is also spraying a herbicide to counter the weed plants 36. In this example, a first treatment indicator is the presence of crop 35 and a second treatment indicator is the presence of weed 36. The amount of spraying is here performed in a substantially continuous way based on the detected amount of weed 36. Although here the amount of weed is depicted in a stepwise manner, ranging from one to four weed plants 36, the detected amount of weed can be determined in a continuous way, for example based on a detected biomass. Herbicide can then be sprayed proportional to the detected biomass. Here, for example, the treatment component can be activated to spray a variable dosage of herbicide based on the amount of detected weed 36. In this example, a dosage of 25% is applied if the number of weed plants 36 in a subarea is one, a dosage of 50% is applied if the number of weed plants 36 in a subarea is two, a dosage of 75% is applied if the number of weed plants 36 in a subarea is three and a dosage of 100% is applied if the number of weed plants 36 in a subarea is four or higher.

In this example the treatment savings parameter for row D″ could be derived in real time to 1−(75%+75%+25%+50%+50%)/5=45%, for row C″ 1−(25%+25%+75%+100%+75%)/5=40%, for B″ 1−(0%+0%+50%+75%+0%)/5=75% and for A″ 1−(0%+50%+25%+50%+0%)/5=75%. An accumulated treatment savings parameter for a treatment starting from row D″ to row A″ could then be derived to be 45% after treating row D″, 42.5% after treating rows D″ and C″, 53.3% after treating rows D″ to B″ and 58.75% after treating rows D″ to A″.

In general, treatment savings parameter can alternatively or additionally be based on data from at least one of the following:
status information of at least one treatment component,
position information of at least one treatment component,
area information of an area treated by at least one treatment component,
area information of area to be treated by at least one treatment component,
a location-specific on/off-operation of at least one treatment component,
on the number of off-operations of at least one treatment component,
on the number of on-operations of at least one treatment component,
on the duration of off-operations of at least one treatment component,
on the duration of on-operations of at least one treatment component,
an aggregation for different positions on the agricultural field during operation of at least one treatment component,
reference information based on at least one of the following:
   a non-location-specific application of the treatment,
   a non-location-specific application of at least one treatment component,
   a non-location-specific application per treatment component,
   a non-location-specific application per position information.

Additionally or alternatively, historic data can be used to compare the real-time treatment with a historic treatment or data from a treatment of another agricultural field can be used to compare with the actual treatment.

Data used for the treatment savings parameter can come from the processed real-time location-specific sensor data, such as from a determined location-specific amount of treatment or from control data, but also for example from machine data, external sources, such as external databases, or from other sensor devices, for example a tank sensor.

In a further embodiment the treatment savings parameter is stored on a storage device. This way applied maps can be recorded by storing the time, treatment savings parameter corresponding to such time, the position corresponding to such time and optionally the activation signal information coming from control data corresponding to such time. As a result, the data collected during operation can be stored and used after operation for further analysis. Here the real or determined treatment may be recorded optionally together with the activation signal including the information on which treatment component was triggered when with which activation signal. In this way the treatment savings parameter can be provided for further use, for example for another treatment, another type of treatment or another agricultural machine as input for a treatment.

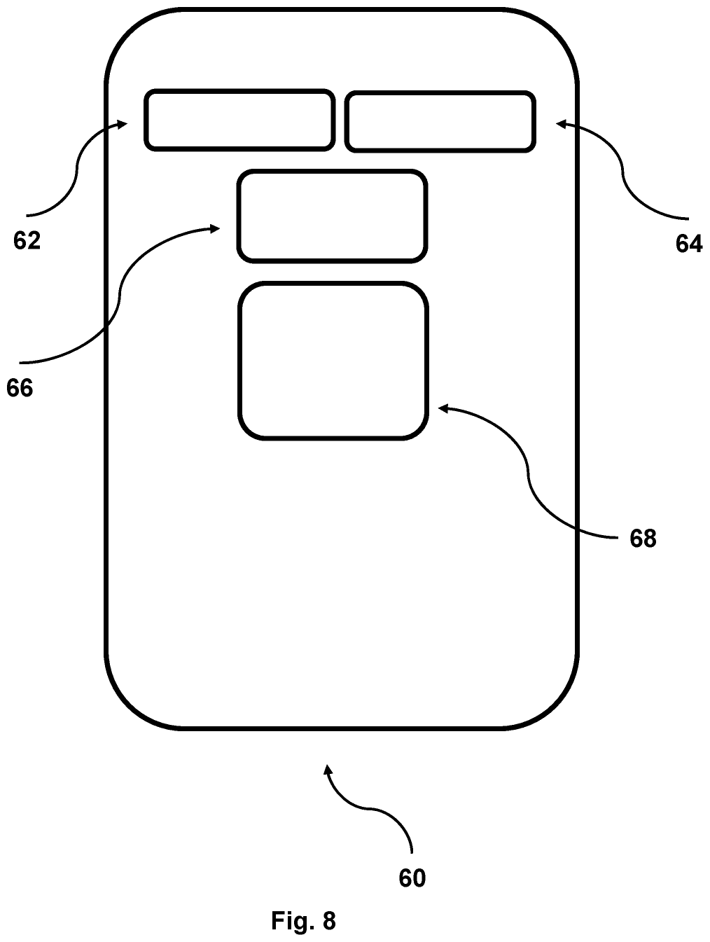

FIG. 8 depicts exemplarily a display output of a display, operatively coupled with an agricultural machine performing the methods provided above. On display 60 information is provided:
about the agricultural field 62,
about at least one treatment indicator 64,
about the progress of the treatment 66, and
the treatment savings parameter 68 in real time and/or accumulated.

The displayed information may be updated in real-time or at a specific frequency, for example 1 Hz. Exemplarily, the treatment savings parameter 68 can be updated based on the provided treatment savings parameter or the information about the agricultural field 62 based on location data.

Additionally, the display output may be modified based on external input, especially on input from a human-machine interface, for example from an operator of the agricultural machine. For example, a treatment indicator or other performance parameter may be modified based on external input.

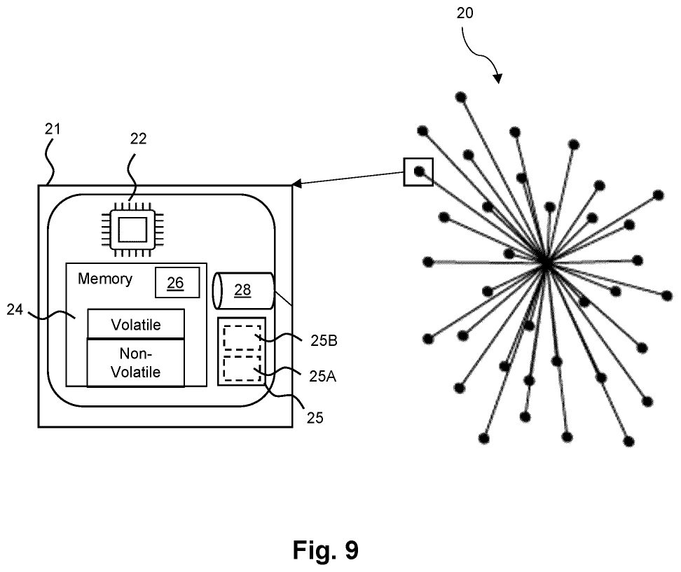

FIGS. 9 to 11 illustrate different computing environments, central, decentral and distributed. The methods, apparatuses, computer elements of this disclosure may be implemented in decentral or at least partially decentral computing environments. In particular, for data sharing or exchange in ecosystems of multiple players different challenges exist. Data sovereignty may be viewed as a core challenge. It can be defined as a natural person's or corporate entity's capability of being entirely self-determined with regard to its data. To enable this particular capability related aspects, including requirements for secure and trusted data exchange in business ecosystems, may be implemented across the chemical value chain. In particular, chemical industry requires tailored solutions to deliver chemical products in a more sustainable way by using digital ecosystems. Providing, determining or processing of data may be realized by different computing nodes, which may be implemented in a centralized, a decentralized or a distributed computing environment.

FIG. 9 illustrates an example embodiment of a centralized computing system 20 comprising a central computing node 21 (filled circle in the middle) and several peripheral computing nodes 21.1 to 21.n (denoted as filled circles in the periphery). The term “computing system” is defined herein broadly as including one or more computing nodes, a system of nodes or combinations thereof. The term “computing node” is defined herein broadly and may refer to any device or system that includes at least one physical and tangible processor, and/or a physical and tangible memory capable of having thereon computer-executable instructions that are executed by a processor. Computing nodes are now increasingly taking a wide variety of forms. Computing nodes may, for example, be handheld devices, production facilities, sensors, monitoring systems, control systems, appliances, laptop computers, desktop computers, mainframes, data centers, or even devices that have not conventionally been considered a computing node, such as wearables (e.g., glasses, watches or the like). The memory may take any form and depends on the nature and form of the computing node.

In this example, the peripheral computing nodes 21.1 to 21.n may be connected to one central computing system (or server). In another example, the peripheral computing nodes 21.1 to 21.n may be attached to the central computing node via e.g. a terminal server (not shown). The majority of functions may be carried out by, or obtained from the central computing node (also called remote centralized location). One peripheral computing node 21.n has been expanded to provide an overview of the components present in the peripheral computing node. The central computing node 21 may comprise the same components as described in relation to the peripheral computing node 21.n.

Each computing node 21, 21.1 to 21.n may include at least one hardware processor 22 and memory 24. The term “processor” may refer to an arbitrary logic circuitry configured to perform basic operations of a computer or system, and/or, generally, to a device which is configured for performing calculations or logic operations. In particular, the processor, or computer processor may be configured for processing basic instructions that drive the computer or system. It may be a semi-conductor based processor, a quantum processor, or any other type of processor configures for processing instructions. As an example, the processor may comprise at least one arithmetic logic unit (“ALU”), at least one floating-point unit (“FPU)”, such as a math coprocessor or a numeric coprocessor, a plurality of registers, specifically registers configured for supplying operands to the ALU and storing results of operations, and a memory, such as an L1 and L2 cache memory. In particular, the processor may be a multicore processor. Specifically, the processor may be or may comprise a Central Processing Unit (“CPU”). The processor may be a (“GPU”) graphics processing unit, (“TPU”) tensor processing unit, (“CISC”) Complex Instruction Set Computing microprocessor, Reduced Instruction Set Computing (“RISC”) microprocessor, Very Long Instruction Word (“VLIW”) microprocessor, or a processor implementing other instruction sets or processors implementing a combination of instruction sets. The processing means may also be one or more special-purpose processing devices such as an Application-Specific Integrated Circuit (“ASIC”), a Field Programmable Gate Array (“FPGA”), a Complex Programmable Logic Device (“CPLD”), a Digital Signal Processor (“DSP”), a network processor, or the like. The methods, systems and devices described herein may be implemented as software in a DSP, in a micro-controller, or in any other side-processor or as hardware circuit within an ASIC, CPLD, or FPGA. It is to be understood that the term processor may also refer to one or more processing devices, such as a distributed system of processing devices located across multiple computer systems (e.g., cloud computing), and is not limited to a single device unless otherwise specified.

The memory 24 may refer to a physical system memory, which may be volatile, non-volatile, or a combination thereof. The memory may include non-volatile mass storage such as physical storage media. The memory may be a computer-readable storage media such as RAM, ROM, EEPROM, CD-ROM, or other optical disk storage, magnetic disk storage, or other magnetic storage devices, non-magnetic disk storage such as solid-state disk or any other physical and tangible storage medium which can be used to store desired program code means in the form of computer-executable instructions or data structures and which can be accessed by the computing system. Moreover, the memory may be a computer-readable media that carries computer-executable instructions (also called transmission media). Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computing system RAM and/or to less volatile storage media at a computing system. Thus, it should be understood that storage media can be included in computing components that also (or even primarily) utilize transmission media.

The computing nodes 21, 21.1 to 21.n may include multiple structures 26 often referred to as an “executable component, executable instructions, computer-executable instructions or instructions”. For instance, memory 24 of the computing nodes 21, 21.1 to 21.n may be illustrated as including executable component 26. The term “executable component” or any equivalent thereof may be the name for a structure that is well understood to one of ordinary skill in the art in the field of computing as being a structure that can be software, hardware, or a combination thereof or which can be implemented in software, hardware, or a combination. For instance, when implemented in software, one of ordinary skill in the art would understand that the structure of an executable component includes software objects, routines, methods, and so forth, that is executed on the computing nodes 21, 21.1 to 21.n, whether such an executable component exists in the heap of a computing node 21, 21.1 to 21.n, or whether the executable component exists on computer-readable storage media. In such a case, one of ordinary skill in the art will recognize that the structure of the executable component exists on a computer-readable medium such that, when interpreted by one or more processors of a computing node 21, 21.1 to 21.n (e.g., by a processor thread), the computing node 21, 21.1 to 21n is caused to perform a function. Such a structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”. Examples of executable components implemented in hardware include hardcoded or hard-wired logic gates, that are implemented exclusively or near-exclusively in hardware, such as within a field-programmable gate array (FPGA), an application-specific integrated circuit (ASIC), or any other specialized circuit. In this description, the terms “component”, “agent”, “manager”, “service”, “engine”, “module”, “virtual machine” or the like are used synonymous with the term “executable component.

The processor 22 of each computing node 21, 21.1 to 21.n may direct the operation of each computing node 21, 21.1 to 21.n in response to having executed computer-executable instructions that constitute an executable component. For example, such computer-executable instructions may be embodied on one or more computer-readable media that form a computer program product. The computer-executable instructions may be stored in the memory 24 of each computing node 21, 21.1 to 21.n. Computer-executable instructions comprise, for example, instructions and data which, when executed at a processor 21, cause a general purpose computing node 21, 21.1 to 21.n, special purpose computing node 21, 21.1 to 21.n, or special purpose processing device to perform a certain function or group of functions. Alternatively or in addition, the computer-executable instructions may configure the computing node 21, 21.1 to 21.n to perform a certain function or group of functions. The computer executable instructions may be, for example, binaries or even instructions that undergo some translation (such as compilation) before direct execution by the processors, such as intermediate format instructions such as assembly language, or even source code.

Each computing node 21, 21.1 to 21.n may contain communication channels 28 that allow each computing node 21.1 to 21.n to communicate with the central computing node 21, for example, a network (depicted as solid line between peripheral computing nodes and the central computing node in FIG. 9). A “network” may be defined as one or more data links that enable the transport of electronic data between computing nodes 21, 21.1 to 21.n and/or modules and/or other electronic devices. When information is transferred or provided over a network or another communications connection (either hardwired, wireless, or a combination of hardwired or wireless) to a computing node 21, 21.1 to 21.n, the computing node 21, 21.1 to 21.n properly views the connection as a transmission medium. Transmission media can include a network and/or data links which can be used to carry desired program code means in the form of computer-executable instructions or data structures and which can be accessed by a general-purpose or special-purpose computing nodes 21, 21.1 to 21.n. Combinations of the above may also be included within the scope of computer-readable media.

The computing node(s) 21, 21.1 to 21.n may further comprise a user interface system 25 for use in interfacing with a user. The user interface system 25 may include output mechanisms 25A as well as input mechanisms 25B. The principles described herein are not limited to the precise output mechanisms 25A or input mechanisms 25B as such will depend on the nature of the device. However, output mechanisms 25A might include, for instance, displays, speakers, displays, tactile output, holograms and so forth. Examples of input mechanisms 25B might include, for instance, microphones, touchscreens, holograms, cameras, keyboards, mouse or other pointer input, sensors of any type, and so forth.

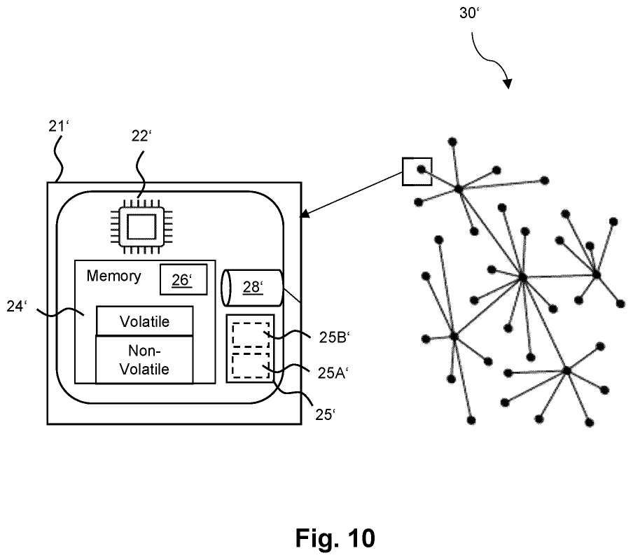

FIG. 10 illustrates an example embodiment of a decentralized computing environment 30 with several computing nodes 21.1 to 21.n denoted as filled circles. In contrast to the centralized computing environment 20 illustrated in FIG. 9, the computing nodes 21.1 to 21.n of the decentralized computing environment are not connected to a central computing node 21 and are thus not under control of a central computing node. Instead, resources, both hardware and software, may be allocated to each individual computing node 21.1 to 21.n (local or remote computing system) and data may be distributed among various computing nodes 21.1 to 21.n to perform the tasks. Thus, in a decentral system environment, program modules may be located in both local and remote memory storage devices. One computing node 21 has been expanded to provide an overview of the components present in the computing node 21. In this example, the computing node 21 comprises the same components as described in relation to FIG. 9.

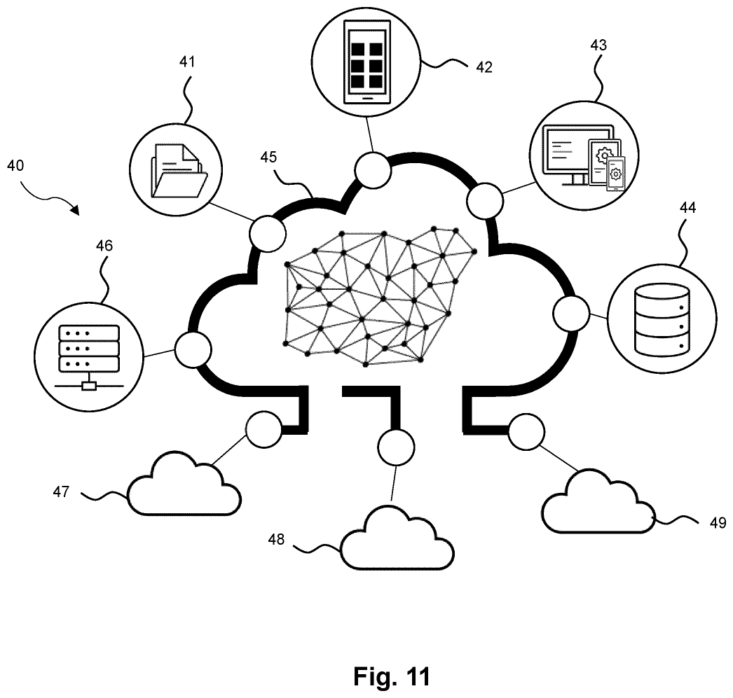

FIG. 11 illustrates an example embodiment of a distributed computing environment 40. In this description, “distributed computing” may refer to any computing that utilizes multiple computing resources. Such use may be realized through virtualization of physical computing resources. One example of distributed computing is cloud computing. “Cloud computing” may refer a model for enabling on-demand network access to a shared pool of configurable computing resources (e.g., networks, servers, storage, applications, and services). When distributed, cloud computing environments may be distributed internationally within an organization and/or across multiple organizations. In this example, the distributed cloud computing environment 40 may contain the following computing resources: mobile device(s) 42, applications 43, databases 44, data storage and server(s) 46. The cloud computing environment 40 may be deployed as public cloud 47, private cloud 48 or hybrid cloud 49. A private cloud 47 may be owned by an organization and only the members of the organization with proper access can use the private cloud 48, rendering the data in the private cloud at least confidential. In contrast, data stored in a public cloud 48 may be open to anyone over the internet. The hybrid cloud 49 may be a combination of both private and public clouds 47, 48 and may allow to keep some of the data confidential while other data may be publicly available.

The present disclosure has been described in conjunction with a preferred embodiment as examples as well. However, other variations can be understood and effected by those persons skilled in the art and practicing the claimed invention, from the studies of the drawings, this disclosure and the claims. Notably, in particular, the any steps presented can be performed in any order, i.e. the present invention is not limited to a specific order of these steps. Moreover, it is also not required that the different steps are performed at a certain place or at one node of a distributed system, i.e. each of the steps may be performed at a different nodes using different equipment/data processing units.

In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

1. A computer-implemented method for monitoring the treatment of an agricultural field (11) with a pesticide product by an agricultural machine (10), wherein the agricultural machine (10) comprises at least one sensor device (31) and at least one treatment component comprising at least one nozzle (21), the method comprising:
providing (400) location-specific sensor data of the agricultural field (10) from the at least one sensor device (31);
analyzing (420) the location-specific sensor data with respect to at least one harmful organism as one treatment indicator;
generating (430) location-specific control data for the at least one treatment component based on the analyzed location-specific sensor data; and
providing (440) a pesticide savings parameter in real-time, wherein the pesticide savings parameter relates to an amount of pesticide product based on the location-specific sensor data in relation to an amount of pesticide product based on a reference treatment with a pesticide product.

2. The computer-implemented method according to claim 1, wherein the pesticide product is a herbicide product, the sensor device (31) comprises at least one optical sensor (31) and a number of weed plants and/or a density of weed is the at least one treatment indicator.

3. The computer-implemented method according to claim 1, further comprising:
adopting the control data for the at least one treatment component such that:
the pesticide savings parameter is set to 0; or
an application is made with a predetermined application rate; or
the threshold value for the application of the pesticide product is decreased or increased.

4. The method according to claim 1, wherein the location-specific control data relates to a location-specific on/off-operation of at least one treatment component.

5. The method according to claim 1, further comprising:
controlling the at least one treatment component based on the location-specific control data.

6. The method according to claim 1, wherein the amount of treatment based on a reference treatment is not location-specific.

7. The method according to claim 1, further comprising:
displaying the treatment savings parameter on a display unit.

8. The method according to claim 7, further comprising:
updating the treatment savings parameter in real time.

9. The method according to claim 1, wherein the treatment savings parameter is stored in a map of the agricultural field, in particular in a location-specific map of the agricultural field.

10. A computing apparatus comprising a communication interface for receiving and sending data, the computing apparatus configured to receive location-specific sensor data via the communication interface, analyze the location-specific sensor data with respect to at least one treatment indicator, generate control data, and send out the control data via the communication interface.

11. A control unit for operating a treatment device (17) for applying a treatment product to an agricultural field (11), the control unit comprises a communication interface for sending and receiving data and the treatment device comprises at least one treatment component (31), wherein the control unit is configured receive control data and to provide control data to control the at least one treatment component (31).

12. A treatment device (17) for applying a treatment product to an agricultural field (11), the treatment device comprising at least one treatment component (21), at least one sensor device (31), wherein the treatment device is adapted to perform the method according to claim 1.

13. An agricultural machine (10) adapted to perform the method according to claim 1.

14. A non-transitory computer readable storage medium comprising computer readable instructions, which when loaded and executed by a computing apparatus, cause the computing apparatus to perform the method of claim 1.
